(19) United States
(12) Patent Application Publication
(10) Pub. No.: US 2026/0087705 A1
(43) Pub. Date: Mar. 26, 2026

(54) METHOD AND APPARATUS FOR STITCHING IMAGES, DEVICE, AND PROGRAM PRODUCT

(71) Applicant: Beijing Zitiao Network Technology Co., Ltd., Beijing (CN)

(72) Inventors: Junliang LU, Beijing (CN); Zhengzheng WAN, Beijing (CN); Fengyi SHANG, Beijing (CN)

(21) Appl. No.: 19/331,913

(22) Filed: Sep. 17, 2025

(30) Foreign Application Priority Data
Sep. 24, 2024 (CN) 202411337146.5

(51) Int. Cl. G06T 11/60; G06F 3/04845; G06T 3/60

(52) U.S. Cl. CPC G06T 11/60; G06F 3/04845; G06T 3/60; G06T 2200/24; G06T 2210/22

(57) ABSTRACT

Embodiments of the present disclosure relate to a method and an apparatus for stitching images, an electronic device, and a product. The method includes detecting rotation of a first image on a canvas by a user, where the canvas includes at least the first image and a second image that are to be stitched. The method further includes determining a rotation angle of the first image in response to detecting the rotation. The method further includes generating a reminder in response to detecting that the rotation angle satisfies a preset condition. In addition, the method further includes stitching the first image and the second image.

### CROSS-REFERENCE TO RELATED APPLICATION(S)

This application claims priority to Chinese Application No. 202411337146.5 filed Sep. 24, 2024, the disclosure of which is incorporated herein by reference in its entireties.

### FIELD

The present disclosure generally relates to the field of computers, and more particularly, to a method and an apparatus for stitching images, an electronic device, and a product.

### BACKGROUND

Image stitching is the process of combining a plurality of individual images into a new image. Image stitching may be classified into automatic stitching and manual stitching. Automatic stitching is a technique that uses software to automatically process a plurality of photos and merge them into a large image. This technique is usually used to create panoramic photos or collages, or seamlessly stitch a plurality of images together to form a larger image.

Manual image stitching refers to the process where users use image editing software or applications to manually combine a plurality of images into a whole. This method grants users complete control over the final result, allowing users to adjust the position, size, rotation angle, etc. of each image according to their own preferences, thereby achieving creative freedom of users.

### SUMMARY

Embodiments of the present disclosure provide a method and an apparatus for stitching images, an electronic device, and a product.

According to a first aspect of the present disclosure, there is provided a method for stitching images. The method includes detecting rotation of a first image on a canvas by a user, where the canvas includes at least the first image and a second image that are to be stitched. The method further includes determining a rotation angle of the first image in response to detecting the rotation. The method further includes generating a reminder in response to detecting that the rotation angle satisfies a preset condition. In addition, the method further includes stitching the first image and the second image.

According to a second aspect of the present disclosure, there is provided an apparatus for stitching images. The apparatus includes a rotation detection module configured to detect rotation of a first image on a canvas by a user, where the canvas includes at least the first image and a second image that are to be stitched. The apparatus further includes a rotation angle determination module configured to determine a rotation angle of the first image in response to detecting the rotation. The apparatus further includes a reminder module configured to generate a reminder in response to detecting that the rotation angle satisfies a preset condition. In addition, the apparatus further includes a stitching module configured to stitch the first image and the second image.

According to a third aspect of the present disclosure, there is provided an electronic device. The electronic device includes a processor and a memory coupled to the processor, where the memory has stored therein instructions that, when executed by the processor, cause the electronic device to perform the method according to the first aspect.

According to a fourth aspect of the present disclosure, there is provided a computer program product having computer-executable instructions stored thereon, where the computer-executable instructions are executed by a processor to implement the method according to the first aspect.

The section Summary is provided to introduce a selection of concepts in a simplified form, which will be further described in the detailed description below. The section Summary is neither intended to identify key features or principal features of the claimed subject matter, nor to limit the scope of the claimed subject matter.

### BRIEF DESCRIPTION OF THE DRAWINGS

The foregoing and other features, advantages and aspects of embodiments of the present disclosure become more apparent with reference to the following detailed description and in conjunction with the accompanying drawings. Throughout the accompanying drawings, the same or similar reference numerals denote the same or similar elements, in which:

FIG. 1 is a schematic diagram of an example environment in which some embodiments of the present disclosure can be implemented;

FIG. 2 is a flowchart of a method for stitching images according to some embodiments of the present disclosure;

FIGS. 3A to 3C are schematic diagrams for stitching images in a free mode according to some embodiments of the present disclosure;

FIGS. 4A to 4E are schematic diagrams for stitching images in a grid mode according to some embodiments of the present disclosure;

FIGS. 5A to 5B are schematic diagrams for changing grid ratios and displaying menu options during image stitching in a grid mode according to some embodiments of the present disclosure;

FIG. 6 is a schematic diagram for determining whether stitching data and an stitching index are present when entering a grid mode according to some embodiments of the present disclosure;

FIG. 7 is a schematic diagram for determining whether an image is cropped when entering a grid mode according to some embodiments of the present disclosure;

FIG. 8 is a block diagram of an apparatus for stitching images according to some embodiments of the present disclosure; and

FIG. 9 is a block diagram of an electronic device according to some embodiments of the present disclosure.

Throughout the accompanying drawings, the same or similar reference numerals denote the same or similar elements.

### DETAILED DESCRIPTION OF EMBODIMENTS

It can be understood that the data involved in the technical solutions (including, but not limited to, the data itself and the access to or use of the data) shall comply with the requirements of corresponding laws, regulations, and relevant provisions.

It can be understood that before the use of the technical solutions disclosed in the embodiments of the present disclosure, the user shall be informed of the type, range of use, use scenarios, etc., of personal information involved in the present disclosure in an appropriate manner in accordance with the relevant laws and regulations, and the authorization of the user shall be obtained.

For example, upon reception of an active request from the user, prompt information is sent to the user to clearly inform the user that a requested operation will require access to and use of the personal information of the user. As such, the user can independently choose, based on the prompt information, whether to provide the personal information to software or hardware, such as an electronic device, an application, a server, or a storage medium, that performs operations in the technical solutions of the present disclosure.

In an alternative but non-limiting implementation, in response to the reception of the active request from the user, the prompt information may be sent to the user in the form of, for example, a pop-up window, in which the prompt information may be presented in text. Furthermore, the pop-up window may further include a selection control for the user to choose whether to “agree” or “disagree” to provide the personal information to the electronic device.

It can be understood that the above-mentioned process of notifying and obtaining the authorization of the user is only illustrative and does not constitute a limitation on the implementations of the present disclosure, and other manners that satisfy the relevant laws and regulations may also be applied in the implementations of the present disclosure.

The embodiments of the present disclosure are described in more detail below with reference to the accompanying drawings. Although some embodiments of the present disclosure are shown in the drawings, it should be understood that the present disclosure may be implemented in various forms and should not be construed as being limited to the embodiments set forth herein. Rather, these embodiments are provided for a more thorough and complete understanding of the present disclosure. It should be understood that the accompanying drawings and the embodiments of the present disclosure are only for exemplary purposes, and are not intended to limit the scope of protection of the present disclosure.

In the description of the embodiments of the present disclosure, the term “include” and similar terms should be understood as open-ended inclusion, namely, “including but not limited to”. The term “based on” should be understood as “at least partially based on”. The term “an embodiment” or “the embodiment” should be understood as “at least one embodiment”. The terms “first”, “second”, and the like may refer to different objects or the same object, unless otherwise explicitly defined. Other explicit and implicit definitions may also be included below.

As mentioned above, manual image stitching offers greater creative freedom. Users may rotate images to different angles during manual image stitching to create stitched images with different layouts. Usually, when rotating images, users tend to rotate the images to some special angles or commonly acceptable angles based on the operating habits and expectations of the users. However, in the related art, when rotating images, users need to rely on their own judgment to determine rotation angles of the images. Although this method largely respects the creative freedom of users, it reduces the efficiency of image stitching because users who are not familiar with image stitching need to precisely adjust the angles of the images every time, which leads to additional time consumption and a plurality of attempts, reducing the user experience.

According to the embodiments of the present disclosure, the method of determining whether a rotation angle of an image satisfies a preset condition to generate a reminder can help users adjust images to corresponding angles, thereby beautifying the layout design of the stitched images. Moreover, the reminder method can also provide intuitive feedback in real time to users who find it difficult to accurately determine the angles, improving the efficiency of image stitching by users, thereby improving the user experience.

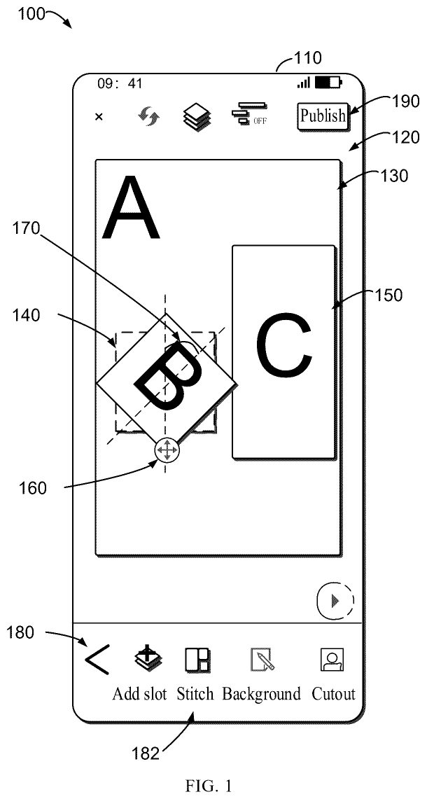

FIG. 1 is a schematic diagram of an example environment 100 in which some embodiments of the present disclosure can be implemented. As shown in FIG. 1, a display interface 110 is an interface for free stitching of stitched images, with the largest portion in the display interface 110 being a canvas 120. The canvas 120 displays three images imported by a user, including an image A 130, an image B 140, and an image C 150. It can be understood that a number of images imported by the user is not limited. The image A 130, the image B 140, and the image C 150 are stacked in an import order by the user. For example, the image A 130 may be the first image imported by the user or the first image selected by the user during the import process. In some embodiments, the image A 130, the image B 140, and the image C 150 are stacked with a center point between them coincident with a center point of the canvas. This may also be a default image displayed when the user enters the display interface 110.

Still referring to FIG. 1, the user may freely adjust the stacking order, sizes, and arrangement angles of the images displayed on the canvas 120. For example, when the image C 150 is selected, the user may freely move the image. For example, the currently displayed image C 150 may have already been moved from the default center point of the canvas to the right side of the canvas. For example, when the image B 140 is selected, the user may long press a button 160 to move the image inward to zoom out the image or to move the image outward to zoom in the image, or may long press the button 160 to rotate the image to adjust the image to an angle that satisfies the user. In some embodiments, the image B 140 may also be rotated by rotating the image by a two-finger long press.

Still referring to FIG. 1, during the process of the user rotating the image B 140 to an appropriate angle, when the user rotates the image to, for example, 45 degrees (or a multiple of 45 degrees), a reminder may be sent to prompt the user that the angle 170 of the current image reaches a system-defined special angle or a commonly acceptable angle (e.g., 45 degrees or a multiple of 45 degrees). For example, it may be a vibration reminder or a text reminder may pop up. In some embodiments, alternatively, when the user rotates the image to approach an angle, for example, when the defined angle is 45 degrees and the rotation reaches ±5 degrees of 45 degrees, a reminder may also be sent to alert the user. For example, it may be a “45 degrees” or “45°” text reminder.

In some embodiments, assuming that the defined angle is 45 degrees, when the user rotates the image to 42 degrees and stops rotation, the image may be automatically corrected to 45 degrees. In some embodiments, the angle may be a rotation angle of a vertically upward symmetry line of the image. In some embodiments, these angles may be multiples of 45 degrees, and in visual arts, a 45-degree angle is often used to create a sense of motion or balance, and considered as an appealing angle. In some embodiments, these angles may also be 30 degrees or 60 degrees or multiples of these angles, and the present disclosure is not limited thereto. In some embodiments, the display interface 110 may also display in real time the rotation angle of the image rotated by the user, which may facilitate the user to determine the margin of rotation.

Still referring to FIG. 1, when the user is satisfied with the rotation angle of the image B 140, and no further adjustments of the image are required, stitching of the images may be completed, and may be saved and published through a publish button 190.

As shown in FIG. 1, a lower region 180 of the display interface 110 display, from left to right, an add slot option, a stitch option 182, a background option, a cutout option, etc., where the add slot option may be used to add slots for images, or may be understood as adding images. When taping on the stitch option 182, the user may enter a grid stitching page where the user may freely set the grid layout of images, and the ratios of grids and the ratio of the canvas. The background option allows the user to edit the background of the image. If the user imports an image that involves a portrait, the portrait layer in the image may be copied using the cutout option. In some embodiments, any shape of layer in the image that is selected by the user may be copied. In some embodiments, before the grid stitching page is entered, the image imported by the user may further be cropped to obtain the image portion that the user needs.

The method of determining whether a rotation angle of an image satisfies a preset condition to generate a reminder can help users adjust images to corresponding angles, thereby beautifying the layout design of the stitched images. Moreover, the reminder method can also provide intuitive feedback in real time to users who find it difficult to accurately determine the angles, improving the efficiency of image stitching by users, thereby improving the user experience.

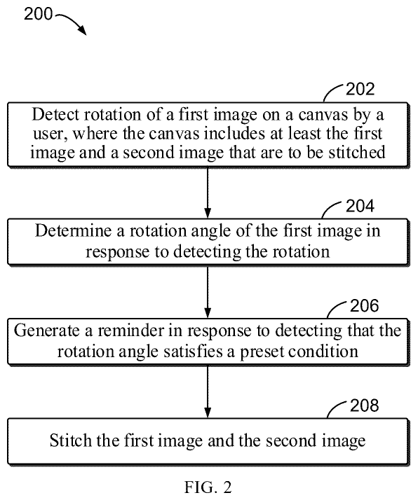

The process according to the embodiments of the present disclosure will be described in detail below in conjunction with FIG. 2 to FIG. 9. For ease of understanding, all the specific data mentioned in the following description is exemplary, and is not intended to limit the scope of protection of the present disclosure. It may be understood that the embodiments described below may further include additional actions not shown and/or may omit actions shown, and the scope of the present disclosure is not limited in this regard.

FIG. 2 is a flowchart of a method 200 for stitching images according to some embodiments of the present disclosure. Referring to FIG. 2, the method 200 includes block 202, block 204, block 206, and block 208. An execution subject of the method 200 may be an apparatus for stitching images, which may be a server, for example, a computing system, a single server, or a distributed server, or may be a system of servers configured in the cloud, or may be a stand-alone apparatus or system. The apparatus may be implemented by software and/or hardware. The method 200 will be described below with the execution subject of the apparatus for stitching images.

At block 202, rotation of a first image on a canvas by a user is detected, where the canvas includes at least the first image and a second image that are to be stitched. Referring to FIG. 1, in a free stitching mode, the canvas 120 displays a plurality of images to be stitched, including an image A 130, an image B 140, and an image C 150. A user may manually perform various operations on the images on the canvas 120. For example, the image B 140 may be selected to rotate the image by long pressing a button 160. When the user rotates the image B 140, rotation of the image B 140 may be detected.

At block 204, a rotation angle of the first image is determined in response to detecting the rotation. When the rotation of the image B 140 is detected, a rotation angle 170 of the image B 140 by the user may be calculated in real time. In some embodiments, the angle 170 may be a rotation angle on a vertically upward symmetry line of the image B 140.

At block 206, a reminder is generated in response to detecting that the rotation angle satisfies a preset condition. When the rotation angle 170 of the image B 140 satisfies a preset condition, for example, the angle 170 satisfies a defined condition of 45 degrees (or a multiple of 45 degrees), a vibration reminder may be sent or a text reminder may pop up, so that the user may know in real time that the rotation of the current image has reached 45 degrees (or a multiple of 45 degrees), thereby improving the operation convenience for the user.

At block 208, the first image and the second image are stitched. Referring to FIG. 1, in some embodiments, when the user taps the publish button 190 in FIG. 1, stitching of the images may be completed through the publish button 190, and the stitched image A, image B, and image C may be saved and published.

In the embodiments of the present disclosure, the method of determining whether a rotation angle of an image satisfies a preset condition to generate a reminder can help users adjust images to corresponding angles, thereby beautifying the layout design of the stitched images. Moreover, the reminder method can also provide intuitive feedback in real time to users who find it difficult to accurately determine the angles, improving the efficiency of image stitching by users, thereby improving the user experience.

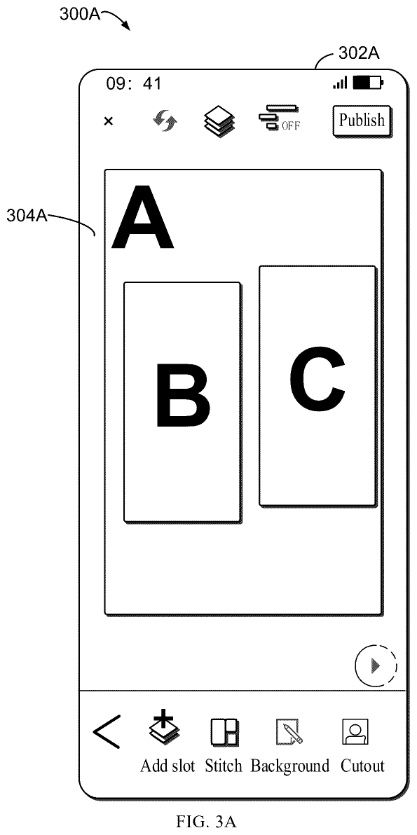

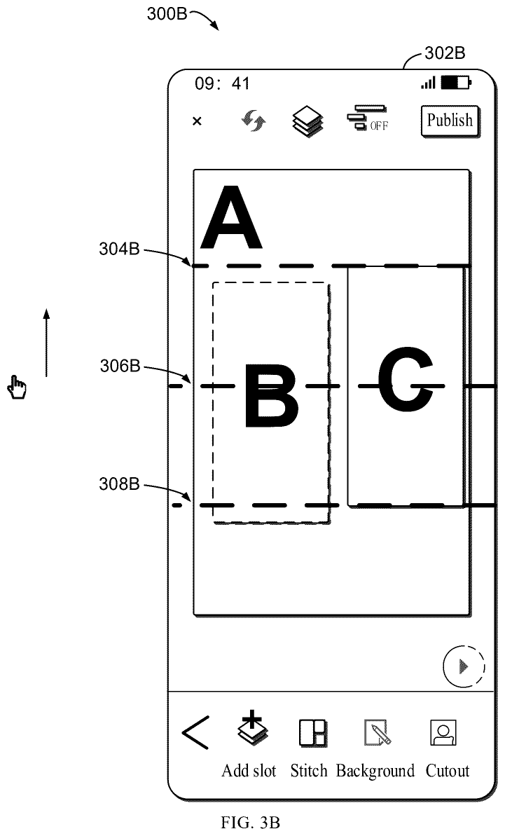

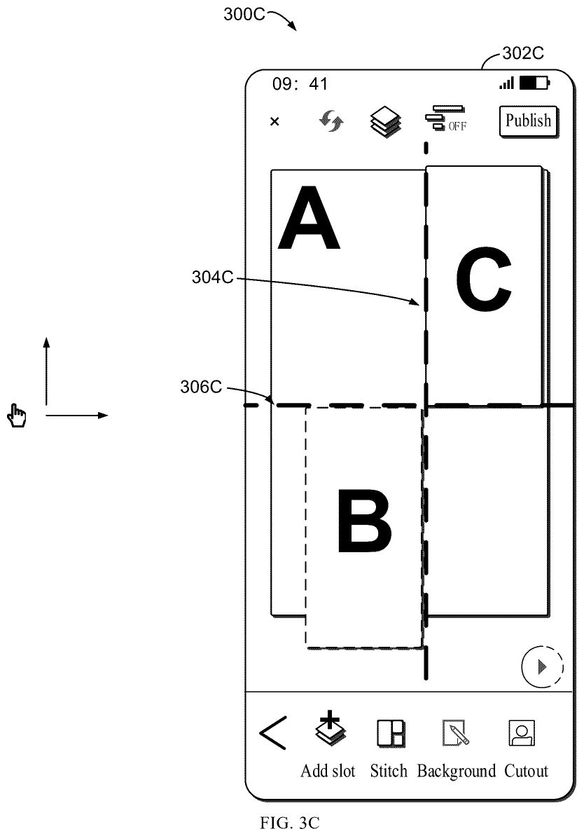

The appearance of guidelines when an image is moved in a free stitching mode in some embodiments of the present disclosure is described in conjunction with FIGS. 3A to 3C. FIG. 3A is a schematic diagram 300A of a display interface in a free mode after a user imports images according to some embodiments of the present disclosure. Referring to FIG. 3A, a canvas 304A of the display interface 302A displays three images imported by the user, including an image A, an image B, and an image C. It can be understood that the layout of the images displayed in the canvas 304A is not the default layout of the images entering the display interface 302A.

In conjunction with FIG. 3B, FIG. 3B is a schematic diagram 300B of the appearance of a horizontal guideline when an image is moved in a free mode according to some embodiments of the present disclosure. Referring to FIG. 3B, when the image B selected, the user may long press and move the image on a display interface 302B to adjust the position of the image B. When the image B is moved to be aligned with the image C on the edge of the image C, a horizontal reference guideline 304B may be displayed on the upper edge of the image C and a horizontal reference guideline 308B may be displayed on the lower edge of the image C.

Likewise, in conjunction with FIG. 3C, FIG. 3C is a schematic diagram 300C of the appearance of a horizontal reference guideline and a vertical reference guideline when an image is moved in a free mode according to some embodiments of the present disclosure. Referring to FIG. 3C, a reference guideline 304C may appear in a display interface 302C when the image B is moved such that an edge of the image B is aligned with an edge of the image C in the vertical direction, and when the edges in the horizontal direction are aligned, a reference guideline 306C may also appear.

Returning to FIG. 3B, a horizontal reference guideline 306B also appears when the image B is moved such that the horizontal centerline of the image C approaches alignment with the horizontal centerline of the image C. Likewise, although not shown in the figures, it can be understood that a vertical reference guideline also appears when the image B is moved such that the vertical centerline of the image B approaches alignment with the vertical centerline of the image C. It can be understood that the reference guidelines may appear simultaneously when the images are aligned at the edge or centerline.

The method of displaying the reference guidelines in real time during movement help users determine in real time whether images still need to be moved, and further enables precise alignment of the images, improving the efficiency of image stitching by users, thereby improving the user experience.

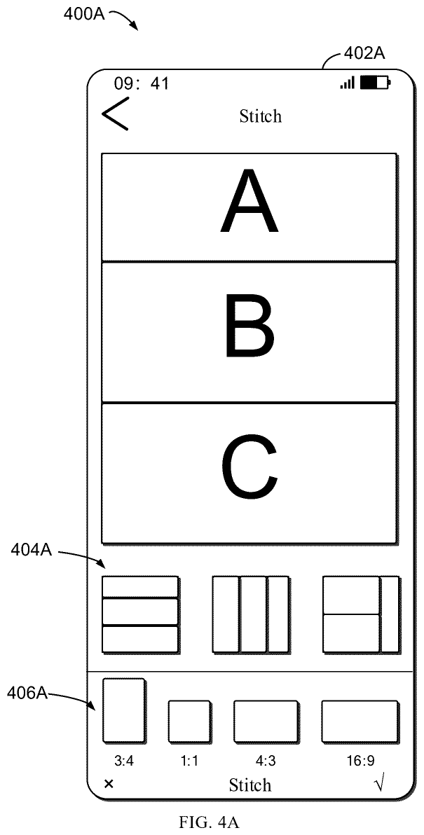

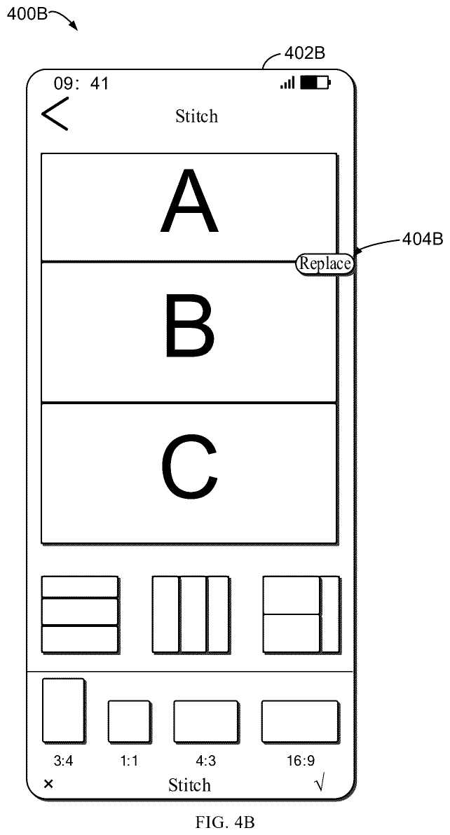

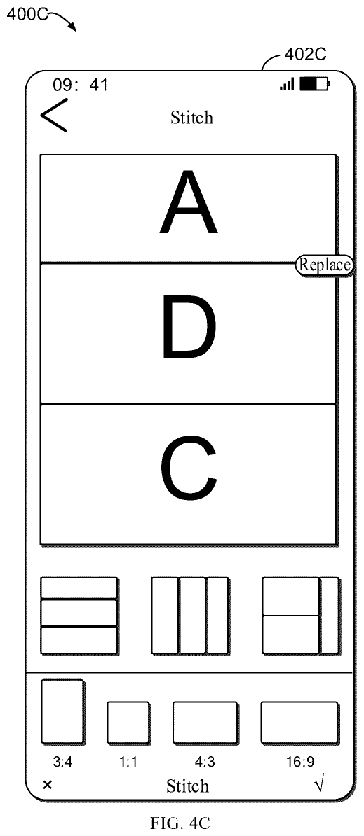

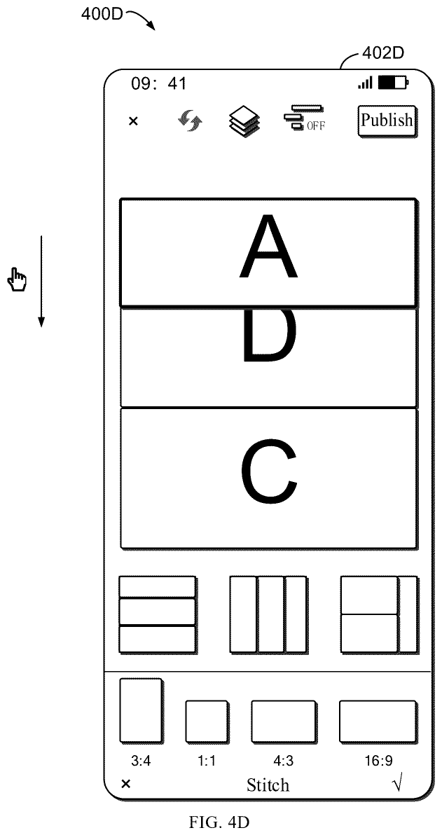

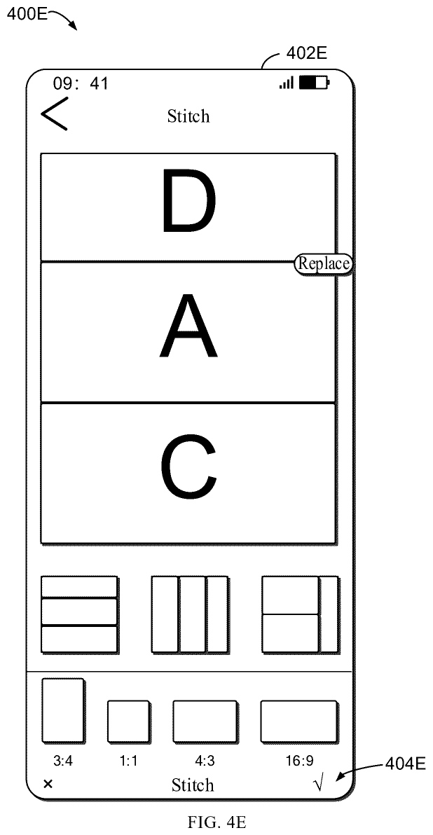

The image stitching in a grid mode in some embodiments of the present disclosure will be described below in conjunction with FIGS. 4A to 4E. FIG. 4A is a schematic diagram of a default grid page 400A displayed after images are imported by a user according to some embodiments of the present disclosure. In conjunction with FIG. 1, when taping on a stitch option 182 after importing the images, the screen may jump to a display page 402A in FIG. 4A, where a region 104A displays grid layout templates. A number of grids in these grid layout templates corresponds to a number of imported images. For example, if three images are imported, a 3-grid grid layout template is displayed. As shown in the region 404A, it may be a 3×1 layout, a 1×3 layout, etc. A region 406A displays templates for the user to select grid ratios, for example, when the user taps to select the ratio of 1:1, the grid ratio in the grid layout and the ratio of the entire grid layout becomes 1:1. In some embodiments, when the image is larger than the region displayed by the grid, the image may be selected and dragged to display other regions of the image.

FIG. 4B is a schematic diagram 400B of an interface from which an image is selected on a grid stitching page according to some embodiments of the present disclosure. Referring to FIG. 4B, in a display interface 402B, when the user taps the image B, a replace button 404B may be displayed in the upper right corner of the image B. When the user taps the replace button 404B, the image B may be replaced. FIG. 4C is a schematic diagram 400C of displaying a newly replaced image during grid stitching according to some embodiments of the present disclosure. As shown in FIG. 4C, in a display interface 402C, the user selects an image D to replace the image B in FIG. 4B.

FIG. 4D is a schematic diagram 400D of swapping image positions on a grid stitching page according to some embodiments in the present disclosure. Referring to FIG. 4D, in a display interface 402D, the user may long press and move the image A in the direction of the image D to swap the positions of the image A and the image D. In some embodiments, the positions of the image A and the image D may also be swapped by long pressing and moving the image A in the direction of the image D.

After the user swaps the positions of the image D and the image A, the screen may jump to FIG. 4E. FIG. 4E is a schematic diagram 400E of an interface obtained after the positions of the images on the grid stitching page are swapped according to some embodiments of the present disclosure. As shown in FIG. 4E, a display interface 402E displays the interface obtained after the positions of the image A and the image D are swapped. After the user does not need to perform other operations on the images on the display interface 402E, the user may tap a confirm button 404E in the lower right corner of the display interface 402E to save settings on the entire stitched image on the interface 402E.

In some embodiments, these data may be save as data files in a JSON form, and the data files include stitching data and an stitching index. For example, in a 1×3 grid, it is possible to set the apex of the upper left corner of the grid as the origin, and the apex of the upper right corner in the horizontal right direction as 1, so that the height of each single image slot (single small grid) is ⅓. Therefore, coordinates of each point may be determined and these data may be stored in the JSON files. In some embodiments, if the user does not need to publish the stitched image as an effect material template, it may be saved in a draft folder, which may be local or in the cloud. It can be understood that there is no sequential order between the positions of the replaced image and the moved image.

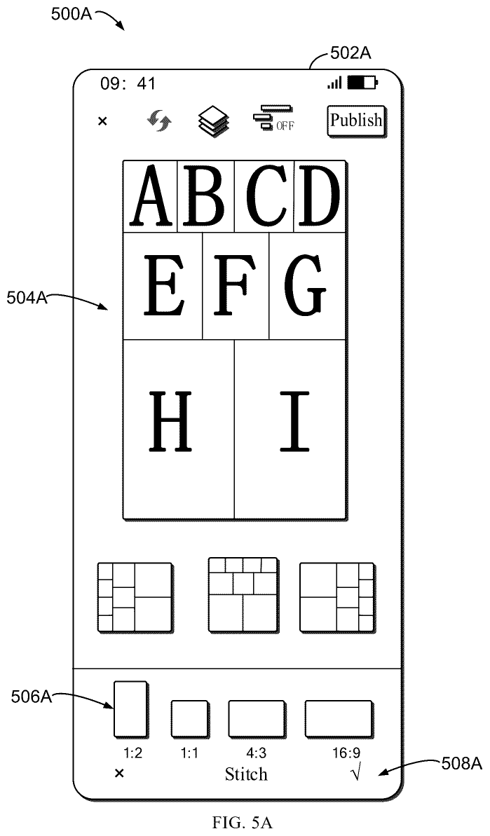

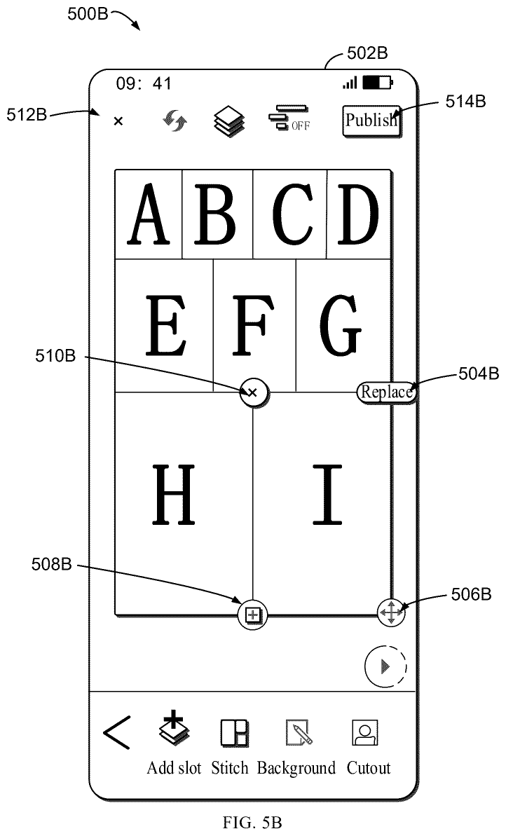

In conjunction with FIG. 5B below, FIGS. 5A to 5B are schematic diagrams for changing grid ratios and displaying menu options during image stitching in a grid mode according to some embodiments of the present disclosure. FIG. 5A is a schematic diagram 500A of a stitching display interface that a user has set. Referring to FIG. 5A, in a display interface 502A (i.e., a stitching page), the user may adjust the overall ratio of a stitched image 504A through a region 506A. It can be understood that the ratios of the images A, B, C, D, E, F, G, H, and I in grids may also be varied.

Still referring to FIG. 5A, the screen may jump to FIG. 5B when the user taps a confirm button 508A. FIG. 5B is a schematic diagram 500B of swapping image positions on a grid stitching page according to some embodiments in the present disclosure. Referring to FIG. 5B, in a display interface 502B (i.e., canvas), when the user taps the image I, a plurality of buttons may appear at four corners of the image I, including a replace button 504B, a rotation button 506B, a copy button 508B, and a delete button 510B. When the user taps the replace button 504B, the replacement of the image I may be achieved. When the user taps the rotation button 506B, operations such as zooming and rotation of the image I may be achieved. In some embodiments, when the user rotates an image to system-defined angle, a vibration reminder may be sent in real time, or a text reminder may pop up in real time. In some embodiments, when the user rotates an image within a reasonable error of the system-defined angle and the user stops the rotation of the image, the angle of the image may be corrected to the system-defined angle. When the user taps the copy button 508B, the copy of the image I may be achieved, i.e., a new image I may be copied on the display interface 502B. The image I is deleted when the user taps the delete button 510B. It can be understood that, in a free stitching mode, when the user taps the image, the plurality of same buttons may appear at the four corners of the image.

As shown in FIG. 5B, when the user considers that there is no need to operate the stitched image, the edited stitched image may be published as an effect material through a publish button 514B. If the user wants to discard editing of the stitched image, the user may discard editing of the stitched image through an exit button 512B in the upper left corner, or re-determine, in a pop-up option (not shown), whether to save it to the draft folder or discard it directly.

With the button that displays a plurality of functions at the corners of each image, the user may start editing directly at the position, without entering a deep menu structure, which can not only simplify the operation process of the user, but also enhance the overall user experience.

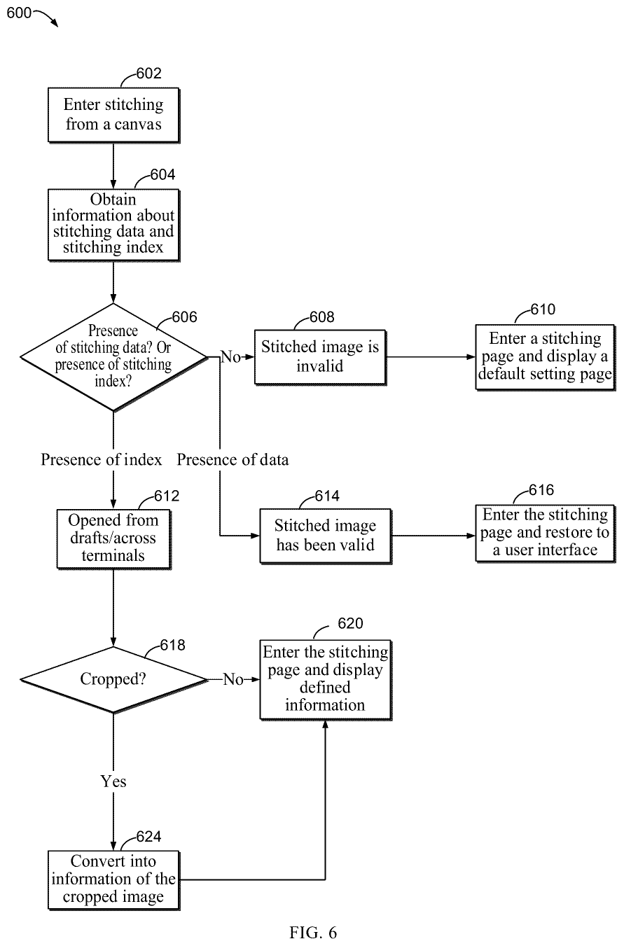

FIG. 6 is a schematic diagram 600 for determining whether stitching data and a stitching index exist when entering a grid mode according to some embodiments of the present disclosure. As shown in FIG. 6, when it is detected that a user enters stitching from a canvas at 602, the user may attempt to obtain any stitching data and index information of stitched images at 604. In this case, it may be determined at 606 whether stitching data and the index information of stitched images are obtained at 604, where the stitching index may refer to an index used to identify and organize the image in each grid, and the stitching data may be actual content data of stitched images.

Still referring to FIG. 6, if neither the stitching data nor the stitching index exist, it may be determined at 608 that a stitched image file is invalid, meaning that there is no data related to image stitching, and the user may enter a stitching page at 610, thereby displaying a default setting page. If the stitching data exists, it may be determined at 614 that the stitched image file has been valid, and the user interface corresponding to the stitching data may be recovered from the stitching data when the stitching page is entered at 616, further including restoring the stitching effect.

Still referring to FIG. 6, if the stitching index exists, it may be considered at 612 that the user opens the stitched image file from other different terminals (e.g., Android to iOS) or from a draft folder. In this case, whether the image in the grid is cropped may be determined at 618. If the image is not cropped, the user may enter the stitching canvas at 620, to display the layout of the image in the grid. If the image is cropped, coordinates of the cropped image may be converted at 624 based on coordinates of the image and vertex coordinates of each grid region, thereby displaying a display region of the cropped image in the grid at 620.

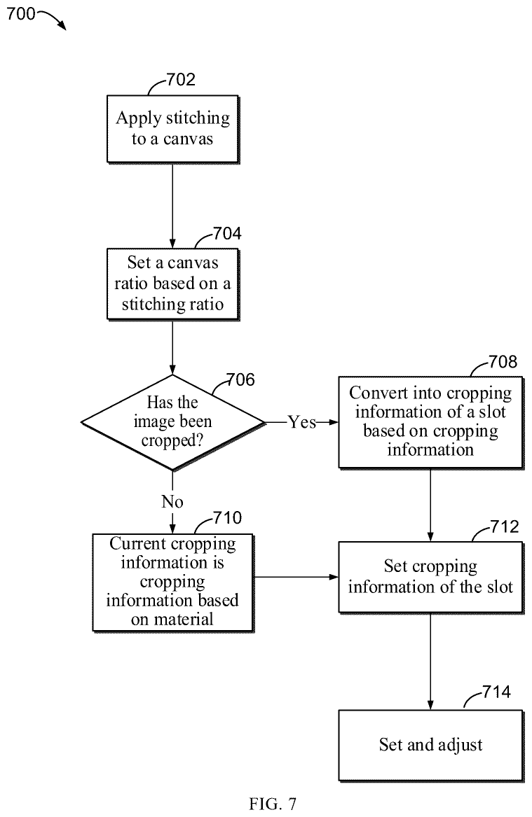

FIG. 7 is a schematic diagram 700 for determining whether an image is cropped when entering a grid mode according to some embodiments of the present disclosure. Referring to FIG. 7, stitching is applied to a canvas at 702, and then a canvas ratio may be set at 704 based on a stitching ratio. In some embodiments, when the user selects the stitching ratio of 1:2, the entire canvas ratio also becomes 1:2. In order for the cropped image to display normally in the grid, whether the image has been cropped may be determined at 706. If the image has been cropped, cropping information of the image relative to a slot (grid) may be converted based on the cropped image information at 708. If the image has not been cropped, it may be obtained at 710 that cropping information of the current image is cropping information of the image relative to the slot, i.e., no conversion is required.

Still referring to FIG. 7, cropping information of the image relative to the slot may be obtained at 712, and then stitching data may be further set and processed at 714, i.e., the related image may finally be displayed in the grid or slot based on the related information obtained at 712. It can be understood that the cropping information here may be converted based on coordinates.

Through the method of coordinate conversion, the cropped image can also be displayed in the image slot normally, enhancing the aesthetic experience of the user.

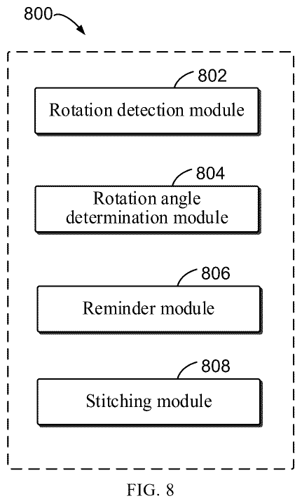

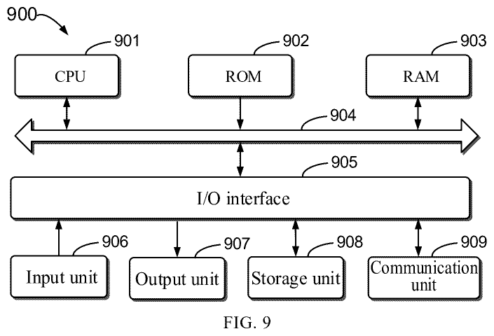

FIG. 8 is a block diagram of an apparatus 700 for stitching images according to some embodiments of the present disclosure. As shown in FIG. 8, the apparatus 800 includes a rotation detection module 802 configured to detect rotation of a first image on a canvas by a user, where the canvas includes at least the first image and a second image that are to be stitched. The apparatus 800 further includes a rotation angle determination module 804 configured to determine a rotation angle of the first image in response to detecting the rotation. The apparatus 800 further includes a reminder module 806 configured to generate a reminder in response to detecting that the rotation angle satisfies a preset condition. In addition, the apparatus 800 further includes a stitching module configured to stitch the first image and the second image. FIG. 9 is a block diagram of an electronic device 900 according to some embodiments of the present disclosure. The device 900 may be a device or an apparatus described in the embodiments of the present disclosure. As shown in FIG. 9, the device 900 includes a central processing unit (CPU) and/or graphics processing unit (GPU) 901 that may perform a variety of appropriate actions and processing in accordance with computer program instructions stored in a read-only memory (ROM) 902 or computer program instructions loaded from a storage unit 908 into a random-access memory (RAM) 903. The RAM 903 may further store various programs and data required for the operation of the device 900. The CPU/GPU 901, the ROM 902, and the RAM 903 are connected to each other via a bus 904. An input/output (I/O) interface 905 is also connected to the bus 904. Although not shown in FIG. 9, the device 900 may further include a coprocessor.

A number of components in the device 900 are connected to the I/O interface 905, including: an input unit 906, such as a keyboard or a mouse; an output unit 907, such as various types of displays or speakers; the storage unit 908, such as a magnetic disk or an optical disk; and a communication unit 909, such as a network card, a modem, or a wireless communication transceiver. The communication unit 909 allows the device 900 to exchange information/data with other devices over a computer network such as the Internet and/or various telecommunication networks.

Each method or process described above may be performed by the CPU/GPU 901. For example, in some embodiments, the method may be implemented as a computer software program tangibly embodied in a machine-readable medium, such as the storage unit 908. In some embodiments, some or all of the computer programs may be loaded into and/or installed onto the device 900 via the ROM 902 and/or the communication unit 909. When the computer program is loaded into the RAM 903 and executed by the CPU/GPU 901, one or more steps or actions in the method or process described above may be performed.

In some embodiments, the methods and processes described above may be implemented as a computer program product. The computer program product may include a computer-readable storage medium on which computer-readable program instructions for performing various aspects of the present disclosure are carried.

The computer-readable storage medium may be a tangible device that can hold and store instructions used by an instruction execution device. The computer-readable storage medium may be, for example, but is not limited to, an electrical storage device, a magnetic storage device, an optical storage device, an electromagnetic storage device, a semiconductor storage device, or any suitable combination thereof. More specific examples of the computer-readable storage medium (a non-exhaustive list) include: a portable computer disk, a hard disk, a random-access memory (RAM), a read-only memory (ROM), an erasable programmable read-only memory (EPROM) (or a flash memory), a static random-access memory (SRAM), a portable compact disk read-only memory (CD-ROM), a digital versatile disk (DVD), a memory stick, a floppy disk, a mechanical coding device, a punched card or an in-groove raised structure on which instructions are for example stored, and any suitable combination thereof. The computer-readable storage medium used herein is not to be interpreted as a transient signal, such as a radio wave or another freely propagating electromagnetic wave, an electromagnetic wave propagating through a waveguide or another transmission medium (e.g., an optical pulse through a fiber-optic cable), or an electrical signal transmitted over a wire.

The computer-readable program instructions described herein may be downloaded from a computer-readable storage medium to each computing/processing device, or downloaded to an external computer or an external storage device over a network, such as the Internet, a local area network, a wide area network, and/or a wireless network. The network may include copper transmission cables, fiber-optic transmission, wireless transmission, routers, firewalls, switches, gateway computers, and/or edge servers. A network adapter card or network interface in each computing/processing device receives computer-readable program instructions from the network and forwards the computer-readable program instructions for storage in the computer-readable storage medium in each computing/processing device.

The computer program instructions for performing the operations of the present disclosure may be assembly instructions, Instruction Set Architecture (ISA) instructions, machine instructions, machine-related instructions, microcode, firmware instructions, status setting data, or source code or object code written in any combination of one or more programming languages, including object-oriented programming languages as well as conventional procedural programming languages. The computer-readable program instructions may be completely executed on a computer of a user, partially executed on a computer of a user, executed as an independent software package, partially executed on a computer of a user and partially executed on a remote computer, or completely executed on a remote computer or server. In a case of the remote computer, the remote computer may be connected to the computer of the user through any kind of network, including a local area network (LAN) or a wide area network (WAN), or may be connected to an external computer (for example, connected through the Internet with the aid of an Internet service provider). In some embodiments, an electronic circuit, such as a programmable logic circuit, a field programmable gate array (FPGA), or a programmable logic array (PLA), is personalized by using state information of the computer-readable program instructions. The electronic circuit may execute the computer-readable program instructions to implement various aspects of the present disclosure.

These computer-readable program instructions may be provided to a processing unit of a general-purpose computer, a special-purpose computer, or another programmable data processing apparatus to produce a machine, such that the instructions, when executed by the processing unit of the computer or the other programmable data processing apparatus, create an apparatus for implementing functions/actions specified in one or more blocks in the flowchart and/or the block diagrams. These computer-readable program instructions may alternatively be stored in the computer-readable storage medium. These instructions enable a computer, a programmable data processing apparatus, and/or another device to work in a specific manner. Therefore, the computer-readable medium storing the instructions includes an artifact that includes instructions for implementing various aspects of functions/actions specified in one or more blocks in the flowchart and/or the block diagrams.

Alternatively, the computer-readable program instructions may be loaded onto a computer, another programmable data processing apparatus, or another device, such that a series of operation steps are performed on the computer, the other programmable data processing apparatus, or the other device to produce a computer-implemented process. Therefore, the instructions executed on the computer, the other programmable data processing apparatus, or the other device implement functions/actions specified in one or more blocks in the flowchart and/or the block diagrams.

The flowcharts and the block diagrams in the accompanying drawings illustrate possible system architectures, functions, and operations of the device, the method, and the computer program product according to a plurality of embodiments of the present disclosure. In this regard, each block in the flowcharts or the block diagrams may represent a part of a module, a program segment, or an instruction. The part of the module, the program segment, or the instruction includes one or more executable instructions for implementing a specified logical function. In some alternative implementations, functions tokenized in the blocks may occur in a sequence different from that tokenized in the accompanying drawings. For example, two consecutive blocks may actually be executed substantially in parallel, or may sometimes be executed in a reverse order, depending on a function involved. It should also be noted that each block in the block diagrams and/or the flowcharts, and a combination of the blocks in the block diagrams and/or the flowcharts may be implemented by a dedicated hardware-based system that executes specified functions or actions, or may be implemented by a combination of dedicated hardware and computer instructions.

Various embodiments of the present disclosure have been described above. The foregoing descriptions are exemplary, not exhaustive, and are not limited to the disclosed embodiments. Many modifications and variations are apparent to a person of ordinary skill in the art without departing from the scope and spirit of the described embodiments. The terminology used in this specification is intended to best explain the principles, practical applications, or technical improvements in the market of the embodiments, or to enable others of ordinary skill in the art to understand the embodiments disclosed herein.

Some example implementations of the present disclosure are listed below.

Example 1. A method for stitching images, comprising:
detecting rotation of a first image on a canvas by a user, the canvas comprising at least the first image and a second image that are to be stitched;
determining a rotation angle of the first image in response to detecting the rotation;
generating a reminder in response to detecting that the rotation angle satisfies a preset condition; and
stitching the first image and the second image.

Example 2. The method according to Example 1, where the rotation angle is a rotation angle of rays starting from a center point of the first image and diverging vertically upward, and the generating a reminder in response to detecting that the rotation angle satisfies a preset condition comprises:
correcting the rotation of the first image by the user to a predetermined angle in response to the rotation angle satisfying the preset condition and in response to detecting the stop of the rotation of the first image by the user.

Example 3. The method according to any one of Examples 1 to 2, where the method further comprises:
determining, in response to detecting movement of the first image on the canvas by the user, whether the first image is aligned with the second image in a vertical direction and/or a horizontal direction of an image edge; and
displaying a first reference guideline in the vertical direction and/or the horizontal direction of the image edge in response to detecting the alignment.

Example 4. The method according to any one of Examples 1 to 3, where the method further comprises:
determining, in response to detecting movement of the first image on the canvas by the user, whether the first image is aligned with the second image on a symmetry line of the image in a vertical direction and/or a horizontal direction; and
displaying a second reference guideline on the symmetry line of the image in the vertical direction and/or the horizontal direction in response to detecting the alignment.

Example 5. The method according to any one of Examples 1 to 4, where the method further comprises:
displaying, in response to a tap of the user on a first option on the canvas, a grid corresponding to a plurality of stitched images on the first region, where the plurality of stitched images are displayed on the first region in an import order.

Example 6. The method according to any one of Examples 1 to 5, where the method further comprises:
displaying a replace button in response to detecting selection of the first image by the user; and
replacing the first image with a third image in response to detecting selection of the replace button by the user.

Example 7. The method according to any one of Examples 1 to 6, where the method further comprises:
swapping positions of the first image and the second image in the first region in response to detecting long press movement of the first image toward the second image by the user.

Example 8. The method according to any one of Examples 1 to 7, where the method further comprises:
displaying the grid on the canvas in response to detecting the tap of the user on a confirm button of the first region;
saving the grid in response to detecting an exit button on the canvas for the user; and
redisplaying the grid in the first region in response to detecting the tap of the user on the saved grid.

Example 9. The method according to any one of Examples 1-8, where the displaying the grid on the canvas in response to detecting the tap of the user on a confirm button of the first region comprises:
displaying a plurality of buttons at four corners of the first image in response to detecting the tap of the user on the first image, the plurality of buttons comprising at least two of a delete button, a replace button, a rotation button, and a copy button, the delete button being used to delete the first image, the replace button being used to replace the first image, the rotation button being used to rotate and/or zoom the first image, and the copy button being used to copy the first image.

Example 10. The method according to any one of Examples 1 to 9, where the method further comprises:
displaying a first region in response to detecting the presence of stitching data, and displaying a user interface corresponding to the stitching data in the first region;
restoring and displaying default settings for the canvas in response to detecting the absence of both the stitching data and a stitching index; and
determining, in response to detecting the presence of the stitching index, whether an image is cropped.

Example 11. The method according to any one of Examples 1 to 10, where the method further comprises:
displaying a first region in response to detecting the presence of stitching data, and displaying a user interface corresponding to the stitching data in the first region;
restoring and displaying default settings for the canvas in response to detecting the absence of both the stitching data and a stitching index; and
determining, in response to detecting the presence of the stitching index, whether an image is cropped.

Example 12. An apparatus for stitching images, comprising:
a rotation detection module configured to detect rotation of a first image on a canvas by a user, the canvas comprises at least the first image and a second image that are to be stitched;
a rotation angle determination module configured to determine a rotation angle of the first image in response to detecting the rotation;
a reminder module configured to generate a reminder in response to detecting that the rotation angle satisfies a preset condition; and
a stitching module configured to stitch the first image and the second image.

Example 13. The apparatus according to Example 12, where the rotation angle is a rotation angle of rays starting from a center point of the first image and diverging vertically upward, and the reminder generation module comprises:
a correction module configured to correct the rotation of the first image by the user to a predetermined angle in response to the rotation angle satisfying the preset condition and in response to detecting the stop of the rotation of the first image by the user.

Example 14. The apparatus according to any one of Examples 12 to 13, further comprising:
a first determination module configured to determine, in response to detecting movement of the first image on the canvas by the user, whether the first image is aligned with the second image in a vertical direction and/or a horizontal direction of an image edge; and
a first display module configured to display a first reference guideline in the vertical direction and/or the horizontal direction of the image edge in response to detecting the alignment.

Example 15. The apparatus according to any one of Examples 12 to 14, further comprising:
a second determination module configured to determine, in response to detecting movement of the first image on the canvas by the user, whether the first image is aligned with the second image on a symmetry line of the image in a vertical direction and/or a horizontal direction; and
a second display module configured to display a second reference guideline on the symmetry line of the image in the vertical direction and/or the horizontal direction in response to detecting the alignment.

Example 16. The apparatus according to any one of Examples 12 to 15, further comprising:
a third display module configured to display, in response to a tap of the user on a first option on the canvas, a grid corresponding to a plurality of stitched images on the first region, where the plurality of stitched images are displayed on the first region in an import order.

Example 17. The apparatus according to any one of Examples 12 to 16, further comprising:
a fourth display module configured to display a replace button in response to detecting selection of the first image by the user; and
a replacement module configured to replace the first image with a third image in response to detecting selection of the replace button by the user.

Example 18. The apparatus according to any one of Examples 12 to 16, further comprising:
a switching module configured to swap positions of the first image and the second image in the first region in response to detecting long press movement of the first image toward the second image by the user.

Example 19. The apparatus according to any one of Examples 12 to 18, further comprising:
a fifth display module configured to display the grid on the canvas in response to detecting the tap of the user on a confirm button of the first region;
a saving module configured to save the grid in response to detecting an exit button on the canvas for the user; and
a sixth display module configured to redisplay the grid in the first region in response to detecting the tap of the user on the saved grid.

Example 20. The apparatus according to any one of Examples 12 to 19, where the fifth display module comprises:
a seventh display module configured to display a plurality of buttons at four corners of the first image in response to detecting the tap of the user on the first image, the plurality of buttons comprising at least two of a delete button, a replace button, a rotation button, and a copy button, the delete button being used to delete the first image, the replace button being used to replace the first image, the rotation button being used to rotate and/or zoom the first image, and the copy button being used to copy the first image.

Example 21. The apparatus according to any one of Examples 12 to 20, further comprising:
an eighth display module configured to display a first region in response to detecting the presence of stitching data, and displaying a user interface corresponding to the stitching data in the first region;
a ninth display module configured to restore and display default settings for the canvas in response to detecting the absence of both the stitching data and a stitching index; and
a third determination module configured to determine, in response to detecting the presence of the stitching index, whether an image is cropped.

Example 22. The apparatus according to any one of Examples 12 to 21, further comprising:
An update module configured to update coordinate information of the cropped image in response to detecting that the image is cropped; and
a tenth display module configured to display the cropped image on the first region.

Example 23. An electronic device, comprising:
a processor; and
a memory coupled to the processor, where the memory has stored therein instructions that, when executed by the processor, cause the electronic device to perform actions comprising:
detecting rotation of a first image on a canvas by a user, the canvas comprising at least the first image and a second image that are to be stitched;
determining a rotation angle of the first image in response to detecting the rotation;
generating a reminder in response to detecting that the rotation angle satisfies a preset condition; and
stitching the first image and the second image.

Example 24. The electronic device according to Example 23, where the rotation angle is a rotation angle of rays starting from a center point of the first image and diverging vertically upward, and the generating a reminder in response to detecting that the rotation angle satisfies a preset condition comprises:
correcting the rotation of the first image by the user to a predetermined angle in response to the rotation angle satisfying the preset condition and in response to detecting the stop of the rotation of the first image by the user.

Example 25. The electronic device according to any one of Examples 23 to 24, where the actions further comprise:
determining, in response to detecting movement of the first image on the canvas by the user, whether the first image is aligned with the second image in a vertical direction and/or a horizontal direction of an image edge; and
displaying a first reference guideline in the vertical direction and/or the horizontal direction of the image edge in response to detecting the alignment.

Example 26. The electronic device according to any one of Examples 23 to 25, where the actions further comprise:
determining, in response to detecting movement of the first image on the canvas by the user, whether the first image is aligned with the second image on a symmetry line of the image in a vertical direction and/or a horizontal direction; and
displaying a second reference guideline on the symmetry line of the image in the vertical direction and/or the horizontal direction in response to detecting the alignment.

Example 27. The electronic device according to any one of Examples 23 to 26, where the actions further comprise:
displaying, in response to a tap of the user on a first option on the canvas, a grid corresponding to a plurality of stitched images on the first region, where the plurality of stitched images are displayed on the first region in an import order.

Example 28. The electronic device according to any one of Examples 23 to 27, where the actions further comprise:
displaying a replace button in response to detecting selection of the first image by the user; and
replacing the first image with a third image in response to detecting selection of the replace button by the user.

Example 29. The electronic device according to any one of Examples 23 to 28, where the actions further comprise:
swapping positions of the first image and the second image in the first region in response to detecting long press movement of the first image toward the second image by the user.

Example 30. The electronic device according to any one of Examples 23 to 29, where the actions further comprise:
displaying the grid on the canvas in response to detecting the tap of the user on a confirm button of the first region;
saving the grid in response to detecting an exit button on the canvas for the user; and
redisplaying the grid in the first region in response to detecting the tap of the user on the saved grid.

Example 31. The electronic device according to any one of Examples 23-30, where the displaying the grid on the canvas in response to detecting the tap of the user on a confirm button of the first region comprises:
displaying a plurality of buttons at four corners of the first image in response to detecting the tap of the user on the first image, the plurality of buttons comprising at least two of a delete button, a replace button, a rotation button, and a copy button, the delete button being used to delete the first image, the replace button being used to replace the first image, the rotation button being used to rotate and/or zoom the first image, and the copy button being used to copy the first image.

Example 32. The electronic device according to any one of Examples 23 to 31, where the actions further comprise:
displaying a first region in response to detecting the presence of stitching data, and displaying a user interface corresponding to the stitching data in the first region;
restoring and displaying default settings for the canvas in response to detecting the absence of both the stitching data and a stitching index; and
determining, in response to detecting the presence of the stitching index, whether an image is cropped.

Example 33. The electronic device according to any one of Examples 23 to 32, where the actions further comprise:
updating coordinate information of the cropped image in response to detecting that the image is cropped; and
displaying the cropped image on the first region.

Example 34. A computer-readable storage medium having stored thereon computer-executable instructions, where the computer executable instructions are executed by a processor to implement the method according to any one of Examples 1 to 11.

Example 35. A computer program product tangibly stored on a computer-readable medium and comprising computer-executable instructions that, when executed by a device, cause the device to perform the method according to any one of Examples 1 to 11.

Although the present disclosure has been described in a language specific to structural features and/or logical actions of the method, it should be understood that the subject matter defined in the appended claims is not necessarily limited to the specific features or actions described above. In contrast, the specific features and actions described above are merely exemplary forms of implementing the claims.

I/We claim:

1. A method for stitching images, comprising:
detecting rotation of a first image on a canvas by a user, the canvas comprising the first image and a second image;
determining a rotation angle of the first image in response to detecting the rotation;
generating a reminder in response to detecting that the rotation angle satisfies a preset condition; and
stitching the first image and the second image.

2. The method according to claim 1, wherein the rotation angle is a rotation angle of rays starting from a center point of the first image and diverging vertically upward, and the generating a reminder in response to detecting that the rotation angle satisfies a preset condition comprises:
correcting the rotation of the first image by the user to a predetermined angle in response to the rotation angle satisfying the preset condition and in response to detecting the stop of the rotation of the first image by the user.

3. The method according to claim 1, further comprising:
determining, in response to detecting movement of the first image on the canvas by the user, whether the first image is aligned with the second image in a vertical direction and/or a horizontal direction of an image edge; and
displaying a first reference guideline in the vertical direction and/or the horizontal direction of the image edge in response to detecting the alignment.

4. The method according to claim 1, further comprising:
determining, in response to detecting movement of the first image on the canvas by the user, whether the first image is aligned with the second image on a symmetry line of the image in a vertical direction and/or a horizontal direction; and
displaying a second reference guideline on the symmetry line of the image in the vertical direction and/or the horizontal direction in response to detecting the alignment.

5. The method according to claim 1, further comprising:
displaying, in response to a tap of the user on a first option on the canvas, a grid corresponding to a plurality of stitched images on the first region, wherein the plurality of stitched images are displayed on the first region in an import order.

6. The method according to claim 5, further comprising:
displaying a replace button in response to detecting selection of the first image by the user; and
replacing the first image with a third image in response to detecting selection of the replace button by the user.

7. The method according to claim 5, further comprising:
swapping positions of the first image and the second image in the first region in response to detecting long press movement of the first image toward the second image by the user.

8. The method according to claim 7, further comprising:
displaying the grid on the canvas in response to detecting the tap of the user on a confirm button of the first region;
saving the grid in response to detecting an exit button on the canvas for the user; and
redisplaying the grid in the first region in response to detecting the tap of the user on the saved grid.

9. The method according to claim 8, wherein the displaying the grid on the canvas in response to detecting the tap of the user on a confirm button of the first region comprises:
displaying a plurality of buttons at four corners of the first image in response to detecting the tap of the user on the first image, the plurality of buttons comprising at least two of a delete button, a replace button, a rotation button, and a copy button, the delete button being used to delete the first image, the replace button being used to replace the first image, the rotation button being used to rotate and/or zoom the first image, and the copy button being used to copy the first image.

10. The method according to claim 1, further comprising:
displaying a first region in response to detecting the presence of stitching data, and displaying a user interface corresponding to the stitching data in the first region;
restoring and displaying default settings for the canvas in response to detecting the absence of both the stitching data and a stitching index; and
determining, in response to detecting the presence of the stitching index, whether an image is cropped.

11. The method according to claim 10, further comprising:
updating coordinate information of the cropped image in response to detecting that the image is cropped; and
displaying the cropped image on the first region.

12. An electronic device, comprising:
a processor; and
a memory coupled to the processor, wherein the memory has stored therein instructions that, when executed by the processor, cause the electronic device to:
detect rotation of a first image on a canvas by a user, the canvas comprising the first image and a second image;
determine a rotation angle of the first image in response to detecting the rotation;
generate a reminder in response to detecting that the rotation angle satisfies a preset condition; and
stitch the first image and the second image.

13. The device according to claim 12, wherein the rotation angle is a rotation angle of rays starting from a center point of the first image and diverging vertically upward, and wherein the instructions causing the processor to generating a reminder in response to detecting that the rotation angle satisfies a preset condition comprise instructions causing the processor to:
correct the rotation of the first image by the user to a predetermined angle in response to the rotation angle satisfying the preset condition and in response to detecting the stop of the rotation of the first image by the user.

14. The device according to claim 12, further comprising instructions causing the processor to:
determine, in response to detecting movement of the first image on the canvas by the user, whether the first image is aligned with the second image in a vertical direction and/or a horizontal direction of an image edge; and
display a first reference guideline in the vertical direction and/or the horizontal direction of the image edge in response to detecting the alignment.

15. The device according to claim 12, further comprising instructions causing the processor to:
determine, in response to detecting movement of the first image on the canvas by the user, whether the first image is aligned with the second image on a symmetry line of the image in a vertical direction and/or a horizontal direction; and
display a second reference guideline on the symmetry line of the image in the vertical direction and/or the horizontal direction in response to detecting the alignment.

16. The device according to claim 12, further comprising instructions causing the processor to:
display, in response to a tap of the user on a first option on the canvas, a grid corresponding to a plurality of stitched images on the first region, wherein the plurality of stitched images are displayed on the first region in an import order.

17. The device according to claim 16, further comprising instructions causing the processor to:
display a replace button in response to detecting selection of the first image by the user; and
replace the first image with a third image in response to detecting selection of the replace button by the user.

18. The device according to claim 16, further comprising instructions causing the processor to:
swap positions of the first image and the second image in the first region in response to detecting long press movement of the first image toward the second image by the user.

19. The device according to claim 16, further comprising instructions causing the processor to:
display the grid on the canvas in response to detecting the tap of the user on a confirm button of the first region;
save the grid in response to detecting an exit button on the canvas for the user; and
redisplay the grid in the first region in response to detecting the tap of the user on the saved grid.

20. A non-transitory computer-readable medium comprising instructions stored thereon which, when executed by a processor, cause the processor to:
detect rotation of a first image on a canvas by a user, the canvas comprising the first image and a second image;
determine a rotation angle of the first image in response to detecting the rotation;
generate a reminder in response to detecting that the rotation angle satisfies a preset condition; and
stitch the first image and the second image.
